(19) United States
(12) Patent Application Publication
(10) Pub. No.: US 2013/0130044 A1
(43) Pub. Date: May 23, 2013

(54) METHOD FOR FORMING A DECORATIVE COATING ON A GEMSTONE, A DECORATIVE COATING ON A GEMSTONE, AND USES OF THE SAME

(71) Applicants: Jarmo Maula, Espoo (FI); Matti Putkonen, Espoo (FI)

(72) Inventors: Jarmo Maula, Espoo (FI); Matti Putkonen, Espoo (FI)

(73) Assignee: Beneq Oy, Vantaa (FI)

(21) Appl. No.: 13/512,722

(22) PCT Filed: Nov. 19, 2010
(86) PCT No.: PCT/FI10/50940

§ 371 Date: Aug. 6, 2012

(30) Foreign Application Priority Data
Nov. 30, 2009 (FI) 20096262

(51) Int. Cl. A44C 17/00; C04B 41/50

(52) U.S. Cl. CPC A44C 17/007; C04B 41/50
USPC 428/457; 427/162; 428/702; 428/698

(57) ABSTRACT

A decorative coating and a method for forming a decorative coating on a gemstone to change the natural visual appearance of the gemstone. The decorative coating comprises an optically absorbing film. Depositing the absorbing film on the substrate comprises the alternating steps of introducing a first precursor to the reaction space such that at least a portion of the first precursor gets adsorbed onto the surface of the substrate, and subsequently purging the reaction space, and introducing a second precursor to the reaction space such that at least a portion of the second precursor reacts with the portion of the first precursor adsorbed onto the surface of the substrate to form a conformal absorbing film on the substrate comprising the gemstone, and subsequently purging the reaction space. The material of the absorbing film is selected from the group of oxides, carbides, noble metals or a mixture thereof.

### FIELD OF THE INVENTION

The present invention relates to decorative coatings on gemstones. Especially the present invention relates to a decorative coating comprising an absorbing film for changing the natural visual appearance of a gemstone and a method for forming such a de corative coating on a gemstone.

### BACKGROUND OF THE INVENTION

Decorative coatings are commonly employed on objects to modify their appearance. A dielectric thin-film structure can also be deposited on the surface of an object to impart a special appearance to the object by the reflectance spectrum of the structure which is a result of interference of light in the thin-film structure.

An important part of many decorative coatings is a layer which absorbs light in the visible wavelength range. This absorbing film as part of a decorative coating should possess an excellent thickness uniformity since thickness variations of the film may cause significant variations in the visual appearance, especially in the color appearance, of the underlying object. For similar reasons the average thickness of the absorbing film should also be accurately controlled.

Gemstones are objects commonly having a complex three dimensional (3D) shape. It is often desirable to alter or change the natural color of a gemstone by employing a decorative coating on the gemstone. In the field of gemstones this is sometimes referred to as a way for “color enhancement”. However, due to the complex shape of gemstones, the surface of which possibly includes many facets, coating methods of the prior art fall short in their ability to deposit an absorbing film on a gemstone, such that the absorbing film would be conformally and uniformly coated over the arched 3D surface of the gemstone.

For instance, US patent application publication 2007/0157666A1 discloses a gemstone having an absorbing film deposited on a specific region of the surface of the gemstone. Methods disclosed to form the absorbing film in this publication are sputtering, chemical vapor deposition (CVD), physical vapor deposition (PVD), arc source deposition, and low pressure chemical vapor deposition (LPCVD). A problem with these coating methods is their poor ability to uniformly, homogeneously, and conformally coat non-planar (3D) arching surfaces and substrates with complex shapes, such as gemstones. This is especially detrimental in decorative coatings on gemstones where the coating is often intended to provide a specific appearance uniformly over an area on the surface of the gemstone.

The inventors have identified a need for a method to fabricate a decorative coating comprising an absorbing film uniformly, homogeneously, and conformally on a gemstone.

### PURPOSE OF THE INVENTION

A purpose of the present invention is to solve the aforementioned technical problems of the prior art by providing a new type of method for fabricating a decorative coating on a gemstone, a decorative coating on a gemstone, and uses of the same.

### SUMMARY OF THE INVENTION

The method according to the present invention is characterized by what is presented in claim 1.

The decorative coating according to the present invention is characterized by what is presented in claim 7.

The use according to the present invention is characterized by what is presented in claim 10 or 11.

A method according to the present invention is a method for forming a decorative coating on a gemstone to change the natural visual appearance of the gemstone. The decorative coating comprises an optically absorbing film to attenuate the transmission of visible light through the coating. The method comprises the steps of bringing the gemstone into a reaction space, and depositing the absorbing film on a substrate comprising the gemstone. Depositing the absorbing film on the substrate comprises the alternating steps of introducing a first precursor to the reaction space such that at least a portion of the first precursor gets adsorbed onto the surface of the substrate and subsequently purging the reaction space, and introducing a second precursor to the reaction space such that at least a portion of the second precursor reacts with the portion of the first precursor adsorbed onto the surface of the substrate to form a conformal absorbing film on the substrate comprising the gemstone, and subsequently purging the reaction space. The material of the absorbing film is selected from the group of oxides, carbides, noble metals or a mixture thereof.

A product according to the present invention is a decorative coating on a gemstone to change the natural visual appearance of the gemstone. The decorative coating comprises an optically absorbing film to attenuate the transmission of visible light through the coating. The decorative coating is fabricated by a method comprising the steps of bringing the gemstone into a reaction space, and depositing the absorbing film on a substrate comprising the gemstone. Depositing the absorbing film on the substrate comprises the alternating steps of introducing a first precursor to the reaction space such that at least a portion of the first precursor gets adsorbed onto the surface of the substrate and subsequently purging the reaction space, and introducing a second precursor to the reaction space such that at least a portion of the second precursor reacts with the portion of the first precursor adsorbed onto the surface of the substrate to form a conformal absorbing film on the substrate comprising the gemstone, and subsequently purging the reaction space. The material of the absorbing film is selected from the group of oxides, carbides, noble metals or a mixture thereof.

The method of the present invention is used for forming, on a gemstone, a decorative coating comprising a conformal absorbing film, for changing the natural visual appearance of the gemstone.

The decorative coating of the present invention is used on a gemstone for changing the natural visual appearance of the gemstone. The decorative coating comprises a conformal absorbing film.

In this specification, unless otherwise stated, the expression “decorative coating” should be understood as any coating which serves to give a specific visual appearance to the gemstone.

In this specification, unless otherwise stated, the expression “absorbing film” should be understood as a film which serves the purpose of absorbing light.

In this specification, unless otherwise stated, the expression “film” should be understood as a film having any thickness. Hence, unless otherwise stated, the “absorbing film” can be a film of any thickness, and even an absorbing film with a thickness of less than one atomic layer (monolayer) falls within this definition for a film. This is especially true since even a film with a thickness of less than one atomic layer can interact with electromagnetic radiation such that the film absorbs light.

In this specification, unless otherwise stated, the expression “color” should be understood as the visually perceivable property of an object, of e.g. a gemstone, which is dictated by the spectrum of light emerging from the object in the wavelength band which is visible to the human eye. Hence, this definition of color includes in this specification, unless otherwise stated, white, grey, black and other grayscale colors.

In one embodiment of the invention the natural visual appearance of the gemstone is the natural color of the gemstone.

In this specification, unless otherwise stated, the expression “noble metals” should be understood as including ruthenium, rhodium, palladium, silver, osmium, iridium, platinum, and gold.

The steps of introducing a first precursor to the reaction space and introducing a second precursor to the reaction space are performed alternately, i.e. these steps do not markedly overlap in time. This means that the first and the second precursor, responsible for the growth of the preliminary deposit, are not present in large amounts in the same space at the same time. It will however be obvious for a skilled person in light of this specification that residuals of chemicals from the previous step may be present a long time in the reaction chamber. These residuals may be able to affect the following process steps to some extent even though the alternating steps do not markedly overlap in time. In this context, alternation of the two steps is intended to ensure that chemical reactions governing the formation of the absorbing film predominantly occur on or close to the surface of the substrate and not in the gas phase farther away from the surface of the substrate. Unless otherwise stated, this definition also holds for other process steps discussed in this specification which are intended to be alternately performed.

The method of the present invention results in an absorbing film which is highly conformal on the substrate comprising the gemstone. The resulting absorbing film also possesses good thickness uniformity, even over gemstones having complex surface geometries. Among other benefits, this reduces non-homogenous visual appearance, more specifically non-homogeneous color appearance, possibly caused by non-uniform films formed with methods of the prior art, and facilitates e.g. the optical design of decorative coatings on gemstones employing this absorbing film formed according to the method of the present invention.

Without limiting the invention to any specific theory about why the method of the present invention results in the aforementioned advantages, the following theory should nevertheless be considered. The alternate introduction of the precursors to the reaction space exposes the substrate comprising the gemstone to one precursor at a time. This leads to an at least partly self-limiting growth mechanism predominantly governed by adsorption reactions on the surface of the substrate, which results in the advantageous conformality of the absorbing film. This absorbing film also has a thickness profile which is very uniform even over large surface areas. When the precursors responsible for film growth are alternately present in the reaction space the precursors are not able to intermix and the growth of the absorbing film is predominantly governed by adsorption reactions on the surface of the substrate. The kinetics of these adsorption reactions are, on the other hand, governed predominantly by the properties of the surface of the substrate and not so much by the flow dynamics of the precursors over the surface of the substrate and in the reaction space.

As each exposure of the surface of the substrate to a precursor results in a portion of the precursor being adsorbed onto the surface of the substrate, the number of how many times the surface of the substrate is alternately exposed to the precursors can be utilized to control the thickness of the film. These methods of forming the absorbing film on the substrate therefore enable very accurately controlling the thickness of the film. Hence, the total absorption of light in the film, and therefore the darkness of the film, can be accurately controlled.

In one embodiment of the invention the steps of introducing a first precursor to the reaction space, and introducing a second precursor to the reaction space are both carried out two or more times for forming a decorative coating having a thickness between 1 nm to 2 μm on the gemstone. When the thickness of the absorbing film of certain embodiments of the invention is below 1 nm or above 2 μm the film is essentially transparent or opaque, respectively, to human eye. Therefore absorbing films of oxides or carbides according to certain embodiments of the invention, falling within the range of 1 nm to 2 μm, can be efficiently used as filters to change the natural color of the underlying gemstone without completely suppressing the natural hue of the gemstone.

In another embodiment of the invention the pressure in the reaction space is between 0.1 mbar (0.1 hPa) and 100 mbar (100 hPa) when the first or the second precursor is introduced to the reaction space. In another embodiment of the invention the temperature of the surface of the substrate comprising the gemstone is in the range of 150° C. to 600° C. when the first or the second precursor is introduced to the reaction space.

In another embodiment of the invention the method additionally comprises the steps of, depositing a first transparent film having a first refractive index on the absorbing film by alternately introducing precursors to the reaction space, such that at least a portion of the introduced precursor adsorbs onto the substrate, and depositing a second transparent film having a second refractive index, different from the first refractive index, on the first transparent film by alternately introducing precursors to the reaction space, such that at least a portion of the introduced precursor adsorbs onto the substrate, to form a thinfilm interference structure on the absorbing film. In another embodiment of the invention the coating comprises a first transparent film having a first refractive index on the absorbing film, and a second transparent film having a second refractive index, different from the first refractive index, on the first transparent film, to form a thin-film interference structure on the absorbing film. In cases where the thin-film interference structure is viewed as being on top of the absorbing film the color of the gemstone is predominantly determined by the reflectance properties of the interference structure. If the absorbing film is thin, allowing some part of the light to pass through the film, the absorbing film together with the thin-film interference structure and the natural color of the gemstone determines the color appearance.

In certain embodiments of the invention the absorbing film can be employed in the decorative coating, in between the thin-film interference structure and the gemstone, or within an interference structure, to attenuate the transmission of visible light through the coating.

The embodiments of the invention described hereinbefore may be used in any combination with each other. Several of the embodiments may be combined together to form a further embodiment of the invention. A method, a product or a use, to which the invention is related, may comprise at least one of the embodiments of the invention described hereinbefore.

### DETAILED DESCRIPTION OF THE INVENTION

In the following, the present invention will be described in more detail with exemplary embodiments by referring to the accompanying figures, in which

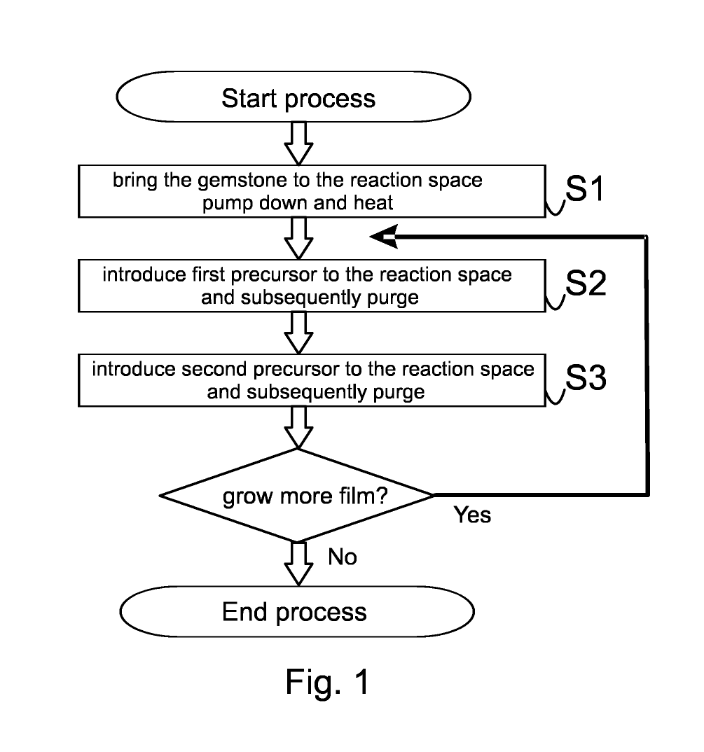

FIG. 1 is a flow-chart illustration of a method according to one embodiment of the present invention,

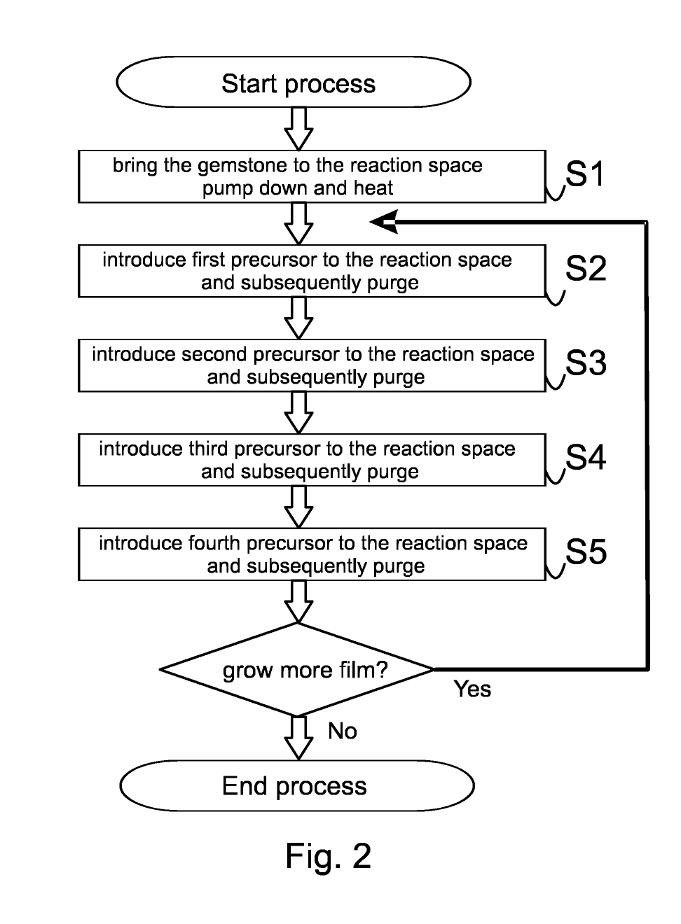

FIG. 2 is a flow-chart illustration of a method according to another embodiment of the present invention,

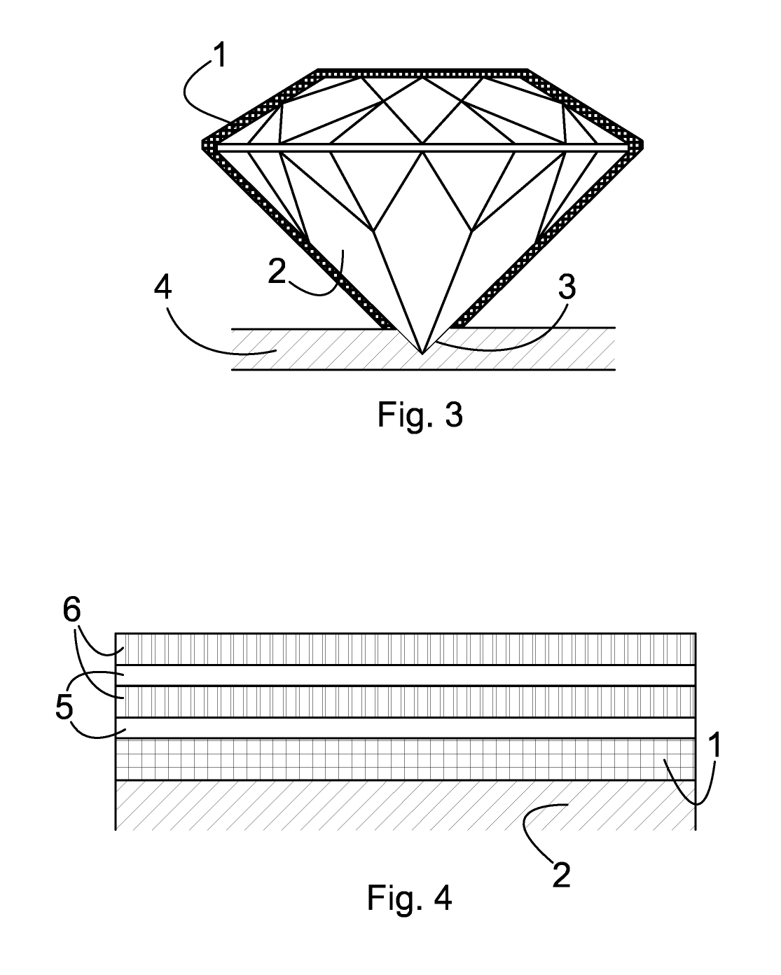

FIG. 3 is a schematic illustration of a multi-faceted gemstone having a decorative coating according to one embodiment of the present invention in a reaction space, and

FIG. 4 is a schematic illustration of a decorative coating on a substrate comprising a gemstone, according to another embodiment of the present invention.

The description below discloses some embodiments of the invention in such a detail that a person skilled in the art is able to utilize the invention based on the disclosure. Not all steps of the embodiments are discussed in detail, as many of the steps will be obvious for the person skilled in the art based on this specification.

Atomic Layer Deposition (ALD) is a method for depositing uniform and conformal thin-films over substrates of various shapes, even over complex 3D (three dimensional) structures. In ALD the coating is grown by alternately repeating, essentially self-limiting, surface reactions between a precursor and a surface to be coated. Therefore the growth mechanism in an ALD process is commonly not as sensitive as in other coating methods to e.g. the flow dynamics inside a reaction chamber, which may be a source for non-uniformity, especially in coating methods relying on gas-phase reactions or in physical deposition methods, such as metal-organic chemical vapor deposition (MOCVD) or physical vapor deposition (PVD).

In an ALD process two or more different chemicals (precursors) are introduced to a reaction space in a sequential, alternating, manner and the precursors adsorb on surfaces inside the reaction space. The sequential, alternating, introduction of precursors is commonly called pulsing (of precursors). In between each precursor pulse there is commonly a purging period during which a flow of gas which does not react with the precursors used in the process is introduced through the reaction space. This gas, often called the carrier gas, is therefore inert towards the precursors used in the process and purges the reaction space from e.g. surplus precursor and by-products resulting from the adsorption reactions of the previous precursor pulse. This purging can be arranged also by other means, and the deposition method can be called by other names such as ALE (Atomic Layer Epitaxy), ALCVD (Atomic Layer Chemical Vapor Deposition), cyclic vapor deposition etc. The essential feature of these methods is to sequentially expose the surface of the substrate to precursors and to growth reactions of precursors essentially on the surface of the substrate.

A film can be grown by an ALD process by repeating several times a pulsing sequence comprising the aforementioned pulses containing the precursor material, and the purging periods. The number of how many times this sequence, called the “ALD cycle”, is repeated depends on the targeted thickness of the film or coating.

Many different apparatuses suitable for carrying out an ALD- or an ALD-like process are disclosed in the prior art, for example in U.S. Pat. No. 6,174,377. A review about the basics of ALD in general is the book; Atomic Layer Epitaxy, by T. Suntola et al., Blackie and Son Ltd., Glasgow, 1990. The construction of a processing tool suitable for carrying out the methods in the following embodiments of the invention will be obvious for the skilled person in light of this specification. The tool can be e.g. a tool suitable for carrying out an ALD process and capable of handling the precursors discussed below. ALD tools (i.e. reactors) are further disclosed in e.g. U.S. Pat. No. 4,389,973 and U.S. Pat. No. 4,413,022 which are included herein as references. Many of the steps related to handling such tools, such as delivering a substrate into the reaction space, pumping the reaction space down to a low pressure or adjusting gas flows in the tool if the process is done at atmospheric pressure, heating the substrates and the reaction space etc., will be obvious for the skilled person. Also, many other known operations or features are not described here in detail nor mentioned, in order to emphasize relevant aspects of the various embodiments of the invention.

In this specification, unless otherwise stated, the term “the surface”, “deposition surface” or “the surface of the substrate” is used to address the surface of the possibly already formed film on the substrate. Hence “the surface”, “deposition surface” or “the surface of the substrate” may change during the method of forming a film on the substrate when precursor chemicals get adsorbed onto the surface.

The exemplary embodiments of the present invention below begin by bringing the gemstone into the reaction space (step S1) of a typical reactor tool, e.g. a tool suitable for carrying out an ALD process. The reaction space is subsequently pumped down to a pressure suitable for forming the film, using e.g. a mechanical vacuum pump. Or, in the case of atmospheric pressure ALD systems and/or processes not requiring a low pressure, gas flows are typically set to protect the deposition zone from the atmosphere. The gemstone is also heated to a temperature suitable for forming the film by the used method. The gemstone can be introduced to the reaction space through e.g. an airtight load-lock system or simply through a loading hatch. The gemstone can be heated by e.g. resistive heating elements which also heat the entire reaction space. Step S1 may also include other preparation procedures, such as growing film on the gemstone or otherwise preparing the gemstone for subsequent process steps. The preparation procedures depend on the reactor tool or on the environment in which the tool is operated. The implementation of these procedures will be obvious for the skilled person in light of this specification.

In step S1 additional pre-treatment steps of the surface of the substrate comprising the gemstone are also possible. The deposition surface can be e.g. exposed to pre-treatment chemical which functionalizes the deposition surface. After this pre-treatment the growth process can proceed e.g. through alternate exposure of the surface of the substrate to the precursors responsible for film growth in the steps S2 and S3. The functionalization of the deposition surface can be used to enable good control of film growth during the first stages of this growth process.

After the gemstone and the reaction space have reached the targeted temperature and other conditions suitable for deposition, an alternate exposure of the surface of the substrate comprising the gemstone to different precursors is started, to conformally form an absorbing film on the gemstone.

The surface of the substrate comprising the gemstone is suitably exposed to precursor chemicals in their gaseous form. This can be realized by first evaporating the precursors in their respective source containers which may or may not be heated depending on the properties of the precursor itself. The evaporated precursor can be delivered into the reaction space by e.g. dosing it through the pipework of the reactor tool comprising flow channels for delivering the vaporized precursors into the reaction space. Controlled dosing of vapor into the reaction space can be realized by valves installed in the flow channels, or by other flow controllers. The valves are commonly called pulsing valves in a system suitable for ALD. Also other mechanisms of bringing the substrate comprising the gemstone into contact with a precursor inside the reaction space may be conceived. One alternative is to make the gemstone (instead of the vaporized precursor) move inside the reaction space such that the gemstone moves through a region occupied by a gaseous precursor.

A typical ALD reactor comprises a system for introducing carrier gas, such as nitrogen or argon, into the reaction space such that the reaction space can be purged from surplus precursor and reaction by-products before introducing the next precursor into the reaction space. This feature together with the controlled dosing of vaporized precursors enables alternately exposing the surface to precursors without significant intermixing of different precursors in the reaction space or in other parts of the reactor. In practice the flow of carrier gas is commonly continuous through the reaction space throughout the deposition process and only the various precursors are alternately introduced to the reaction space with the carrier gas. Obviously, purging of the reaction space does not necessarily result in complete elimination of surplus precursors or reaction by-products from the reaction space but residues of these or other materials may always be present.

Following the step of various preparations (step S1 discussed above), in one embodiment of the present invention, step S2 is carried out, i.e. the surface of the gemstone (or the surface of the substrate comprising the gemstone) is exposed to a first precursor. This embodiment is presented in FIG. 1. Exposure of the surface to the first precursor results, in suitable process conditions disclosed below, in the adsorption of a portion of the first precursor onto the surface. After purging of the reaction space the surface is exposed to a second precursor (step S3), some of which in turn gets adsorbed onto the surface resulting from step S2. Step S2 followed by step S3 results in the formation of optically absorbing film on the gemstone. As explained, each exposure step S2 or S3 results in formation of additional deposit on the surface as a result of adsorption reactions of the corresponding precursor chemical with the surface of the substrate. Thickness of the deposit on the substrate can be increased by repeating the steps S2 and S3 in this order as presented by the flow-chart of FIG. 1. The resulting optically absorbing film possesses the advantageous properties of uniformity and conformality. The thickness of the film can be increased until a targeted level of absorption is reached, after which the alternate exposures are stopped and the process is ended.

In the embodiment of FIG. 1, the shortest repeating sequence of the alternating steps is called a pulsing sequence; the pulsing sequence of the process of FIG. 1 is S2, S3. It will be obvious for a skilled person in light of this specification that other embodiments of the present invention may include additional steps in the pulsing sequence. In these additional steps a third precursor, a fourth precursor etc. can be introduced to the reaction space; i.e. the surface of the substrate comprising the gemstone is exposed to a third and a fourth precursor such that a precursor is able to adsorb onto the surface of the substrate after the previous precursor pulse. An embodiment of the method of the invention including four different precursors in one pulsing sequence is illustrated as a flow-chart in FIG. 2. The pulsing sequence includes the steps of introducing a first (step S2), a second (step S3), a third (step S4) and a fourth (step S5) precursor into the reaction space, each of these steps of course including a purging period after introducing the corresponding precursor to the reaction space.

The embodiments of the present invention result in a uniform absorbing film 1 conforming to the shape of the substrate comprising the gemstone 2. This is schematically illustrated in FIG. 3 where the optically absorbing film 1 has been deposited directly on the gemstone 2 which is placed in a reaction space such that the gemstone 2 rests in a fixture 3 and is supported by a wall 4 of the reaction space. As illustrated by FIG. 3, the wall 4 masks part of the gemstone 2 during the deposition process around the fixture 3 such that the absorbing film 1 is not able to grow on the masked areas of the gemstone. Also other areas of the gemstone 2 can be mechanically masked to deposit the absorbing film 1 on selective areas of a gemstone 2. Correspondingly, fixtures can be designed such that areas having only negligible surface area are masked during the deposition process to enable the deposition of a highly conformal and uniform absorbing film essentially over the entire surface of the gem stone 2.

FIG. 4 presents a decorative coating structure on a substrate comprising a gemstone 2 according to one embodiment of the invention. In the method to fabricate this structure the absorbing film 1 is first formed on the gemstone 2. Subsequently a structure comprising thin-films with a lower refractive index 5 and thin-films with a higher refractive index 6 are formed on the absorbing film 1. The low refractive index films 5 and the high refractive index films 6 alternate in the structure and form an optical interference structure whose reflectance spectrum can be tailored by e.g. modifying the thickness of each film 5 6 in the interference structure. In this structure of FIG. 4 the absorbing film 1 can be used to optically isolate the gemstone 2 and the interference structure between which the absorbing film 1 is formed. As only little visible light is able to penetrate the absorbing film 1 the natural color of the gemstone 2 does not markedly contribute to the color appearance of the coated gemstone 2 and the color is predominantly determined by the interference structure.

It will be obvious for a person skilled in the art that the number of films 5, 6 may vary according to design and according to the targeted reflectance spectrum, i.e. the targeted color. In some embodiments of the invention it is possible to even use a single layer design with only one film 5, 6 on the absorbing film 1. In this case interference occurs between light reflected from the surface of the structure and light reflected from the interface between the one film 5, 6 and the absorbing film 1. It will also be obvious for a skilled person that many different materials can be used even in a single interference structure for the films with the higher and lower refractive index 5, 6 to achieve a targeted interference effect.

In some embodiments of the invention the absorbing film 1, the thin-films with a lower refractive index 5 and the thin-films with a higher refractive index 6 of FIG. 4 are formed in a reactor suitable for ALD in a single process without ejecting the gemstone 2 during the deposition of the structure.

By suitably choosing the chemicals and the process parameters utilized to deposit the absorbing film 1, the adsorption reactions responsible for film-growth exhibit very self-limiting characteristics, and the conformality, uniformity and the homogeneity of the absorbing film 1 can be further improved. The following examples describe in detail how the absorbing film 1 can be grown on the gemstone 2.

### EXAMPLE 1

Optically absorbing films were formed on gemstones according to the embodiment of the invention presented in FIG. 1. The gemstones were first inserted inside the reaction space of a P400 ALD batch tool (available from Beneq OY, Finland). The gemstones were multi-faceted with a complex 3D (non-planar) surface geometry. The gemstones were positioned inside the reaction space in a fixture to support the gemstones and to prevent their movement during the deposition process. In this example the carrier gas discussed above, and responsible for purging the reaction space, was nitrogen (N₂).

After preparations for loading the gemstones into the ALD tool, the reaction space of the ALD tool was pumped down to underpressure and a continuous flow of carrier gas was set, to achieve the processing pressure of about 1 mbar (1 hPa). The gemstones were subsequently heated to the processing temperature of 420° C. The temperature was stabilized to the processing temperature inside the reaction space by a computer controlled heating period of between four to six hours.

After the processing temperature was reached and stabilized, the method moved from step S1 to step S2, according to FIG. 1. The pulsing sequence including step S2, then step S3 was carried out once and then repeated 999 times before the process was ended and the gemstones were ejected from the reaction space and from the ALD tool.

Exposure of the surface of the gemstones to a specific precursor chemical was carried out by introducing the precursor to the reaction space by switching on the pulsing valve of the P400 ALD tool controlling the flow of the specific precursor chemical vapor into the reaction space. Purging of the reaction space was carried out by closing the valves controlling the flow of chemicals into the reaction space, and thereby letting only the carrier gas continuously flow through the reaction space.

The pulsing sequence in this example was in detail as follows; 0.4 s exposure to TiCl₄, 2.0 s purge, 0.5 s exposure to trimethylaluminum, 2.0 s purge. An exposure time and a purge time in this sequence signify a time a specific pulsing valve for a specific precursor was kept open and a time all the pulsing valves for precursors were kept closed, respectively.

The deposition process of this example resulted in a very conformal and uniform film comprising predominantly titanium carbide. The film exhibited high optical absorption, as evaluated by eye, changing the natural color of the gemstones and giving the gemstones an appealing dark hue uniformly over essentially the entire surface of the gemstone.

### EXAMPLE 2

Optically absorbing films were formed on gemstones according to the embodiment of the invention presented in FIG. 1. The gemstones were first inserted inside the reaction space of a P400 ALD batch tool (available from Beneq OY, Finland). The gemstones were multi-faceted with a complex 3D (non-planar) surface geometry. The gemstones were positioned inside the reaction space in a fixture to support the gemstones and to prevent their movement during the deposition process. In this example the carrier gas discussed above, and responsible for purging the reaction space, was nitrogen (N₂).

After preparations for loading the gemstones into the ALD tool, the reaction space of the ALD tool was pumped down to underpressure and a continuous flow of carrier gas was set, to achieve the processing pressure of about 1 mbar (1 hPa). The gemstones were subsequently heated to the processing temperature of 525° C. The temperature was stabilized to the processing temperature inside the reaction space by a computer controlled heating period of between four to six hours.

After the processing temperature was reached and stabilized, the method moved from step S1 to step S2, according to FIG. 1. The pulsing sequence including step S2, then step S3 was carried out once and then repeated 150 times before the process was ended and the gemstones were ejected from the reaction space and from the ALD tool.

Exposure of the surface of the gemstones to a specific precursor chemical was carried out by introducing the precursor into the reaction space by switching on the pulsing valve of the P400 ALD tool controlling the flow of the specific precursor chemical vapor into the reaction space. Purging of the reaction space was carried out by closing the valves controlling the flow of chemicals into the reaction space, and thereby letting only the carrier gas continuously flow through the reaction space.

The pulsing sequence in this example was in detail as follows; 1.0 s exposure to tantalum pentachloride (TaCl₅), 2.0 s purge, 0.5 s exposure to trimethylaluminum (Al(CH₃)₃), 2.0 s purge. An exposure time and a purge time in this sequence signify a time a specific pulsing valve for a specific precursor was kept open and a time all the pulsing valves for precursors were kept closed, respectively.

After the deposition the gemstones were cooled to about 300° C. and then unloaded from the reaction space.

The deposition process of this example resulted in a very conformal and uniform film comprising predominantly carbon and tantalum transition metal. The film exhibited high optical absorption, as evaluated by eye, changing the natural color of the gemstones and giving the gemstones an appealing dark hue uniformly over essentially the entire surface of the gemstone.

### EXAMPLE 3

Optically absorbing films were formed on gem stones according to the embodiment of the invention presented in FIG. 1. The gemstones were first inserted inside the reaction space of a P400 ALD batch tool (available from Beneq OY, Finland). The gemstones were multi-faceted with a complex 3D (non-planar) surface geometry. The gemstones were positioned inside the reaction space in a fixture to support the gemstones and to prevent their movement during the deposition process. In this example the carrier gas discussed above, and responsible for purging the reaction space, was nitrogen (N₂).

After preparations for loading the gemstones into the ALD tool, the reaction space of the ALD tool was pumped down to underpressure and a continuous flow of carrier gas was set, to achieve the processing pressure of about 1 mbar (1 hPa). The gemstones were subsequently heated to the processing temperature of 300° C. The temperature was stabilized to the processing temperature inside the reaction space by a computer controlled heating period of between four to six hours.

After the processing temperature was reached and stabilized, the method moved from step S1 to step S2, according to FIG. 1. The pulsing sequence including step S2, then step S3, was carried out once and then repeated 150 times before the process was ended and the gemstones were ejected from the reaction space and from the ALD tool.

Exposure of the surface of the gemstone to a specific precursor chemical was carried out by introducing the precursor to the reaction space by switching on the pulsing valve of the P400 ALD tool controlling the flow of the specific precursor chemical vapor into the reaction space. Purging of the reaction space was carried out by closing the valves controlling the flow of chemicals into the reaction space, and thereby letting only the carrier gas continuously flow through the reaction space.

The pulsing sequence in this example was in detail as follows; 2.0 s exposure to Ir(acac)₃, 10.0 s purge, 2.0 s exposure to O₂, 2.0 s purge. An exposure time and a purge time in this sequence signify a time a specific pulsing valve for a specific precursor was kept open and a time all the pulsing valves for precursors were kept closed, respectively.

The deposition process of this example resulted in a very conformal and uniform film comprising iridium noble metal. The film exhibited high optical absorption, as evaluated by eye, changing the natural color of the gemstones and giving the gemstones an appealing dark hue uniformly over essentially the entire surface of the gemstone.

### EXAMPLE 4

Optically absorbing films were formed on gemstones according to the embodiment of the invention presented in FIG. 2. The gemstones were first inserted inside the reaction space of a P400 ALD batch tool (available from Beneq OY, Finland). The gemstones were multi-faceted with a complex 3D (non-planar) surface geometry. The gemstones were positioned inside the reaction space in a fixture to support the gemstones and to prevent their movement during the deposition process. In this example the carrier gas discussed above, and responsible for purging the reaction space, was nitrogen (N₂).

After preparations for loading the gemstones into the ALD tool, the reaction space of the ALD tool was pumped down to underpressure and a continuous flow of carrier gas was set, to achieve the processing pressure of about 1 mbar (1 hPa). The gemstones were subsequently heated to the processing temperature of 280° C. The temperature was stabilized to the processing temperature inside the reaction space by a computer controlled heating period of between four to six hours.

After the processing temperature was reached and stabilized, the method moved from step S1 to step S2, according to FIG. 2. The pulsing sequence including step S2, then step S3, then step S4 and then step S5 was carried out once and then repeated 500 times before the process was ended and the gemstones were ejected from the reaction space and from the ALD tool.

Exposure of the surface of the gemstones to a specific precursor chemical was carried out by introducing the precursor to the reaction space by switching on the pulsing valve of the P400 ALD tool controlling the flow of the specific precursor chemical vapor into the reaction space. Purging of the reaction space was carried out by closing the valves controlling the flow of chemicals into the reaction space, and thereby letting only the carrier gas continuously flow through the reaction space.

The pulsing sequence in this example was in detail as follows; 0.6 s exposure to water (H₂O), 1.7 s purge, 0.4 s exposure to titaniumtetrachloride (TiCl₄), 2.2 s purge, 0.5 s exposure to trimethylaluminum (TMA), 3.2 s purge, 0.4 s exposure to titanium-tetrachloride (TiCl₄), 2.2 s purge. An exposure time and a purge time in this sequence signify a time a specific pulsing valve for a specific precursor was kept open and a time all the pulsing valves for precursors were kept closed, respectively.

The deposition process of this example resulted in a very conformal and uniform film comprising predominantly titanium, aluminum and oxygen. The film exhibited high optical absorption, as evaluated by eye, changing the natural color of the gemstones and giving the gemstones an appealing dark hue uniformly over essentially the entire surface of the gemstone.

The construction and configuration of different ALD tools can vary. In above examples each precursor was supplied from a source, which was most suitable for said precursor in the deposition tool and the test conditions used. The presented pulsing sequences should be taken as generic examples of precursor combinations producing the film in an ALD-type process at presented deposition temperatures. Further, it should be taken into consideration that the exposure times and the purging times can vary depending on the deposition tool used.

A wide range of materials can be synthesized and deposited on a substrate comprising a gemstone by alternately exposing the surface of the substrate to different precursors, in an ALD- or in an ALD-like process. The invention is not limited to using the aforementioned precursors and materials in particular and the advantages of the invention can be readily obtained also with other precursors and materials by the skilled person in light of this specification. Furthermore the absorbing film does not necessarily have to be of single material but different materials can be combined in one absorbing film with different ratios by controlling the ratio and order of pulsing sequences corresponding to the different materials. Suitable process chemistries for different materials are extensively disclosed in the literature, in e.g. United States patent application publication number 2004/0208994A1, international patent application publication number WO02/27063A2, Puurunen R. L. Journal of Applied Physics vol. 97 121301 (2005), and Chemical Vapour Deposition: Precursors, Processes and Applications, Chapter 4 Atomic Layer Deposition; Royal Society of Chemistry 2009, which are included as references herein.

Examples of the corresponding suitable materials which can be deposited with methods according to some embodiments of the present invention include, but are not limited to, titanium carbide, tantalum carbide and other carbon and transition metal containing materials, in which the transition metal is selected from a group consisting of titanium, zirconium, hafnium, vanadium, niobium, tantalum, chromium, molybdenum and tungsten. Further examples include, but are not limited to, ruthenium, rhodium, palladium, silver, osmium, gold, iridium, and platinum. Further examples include, but are not limited to, absorbing oxides containing predominantly titanium, aluminum and oxygen.

As is clear for a person skilled in the art, the invention is not limited to the examples and embodiments described above but the embodiments can freely vary within the scope of the claims.

1. A method for forming a decorative coating on a gemstone to change the natural visual appearance of the gemstone, the decorative coating comprising an optically absorbing film to attenuate the transmission of visible light through the coating, the method comprising the steps of bringing the gemstone into a reaction space, and depositing the absorbing film on a substrate comprising the gemstone wherein depositing the absorbing film on the substrate comprises the alternating steps of
introducing a first precursor to the reaction space such that at least a portion of the first precursor gets adsorbed onto the surface of the substrate, and subsequently purging the reaction space, and
introducing a second precursor to the reaction space such that at least a portion of the second precursor reacts with the portion of the first precursor adsorbed onto the surface of the substrate to form a conformal absorbing film on the substrate comprising the gemstone, and subsequently purging the reaction space,
and in that the material of the absorbing film is selected from the group of oxides, carbides, noble metals or a mixture thereof.

2. The method of claim 1, wherein the natural visual appearance of the gemstone is the natural color of the gemstone (2).

3. The method of claim 1, wherein the steps of introducing a first precursor to the reaction space, and introducing a second precursor to the reaction space are both carried out two or more times for forming a decorative coating having a thickness between 1 nm to 2 μm on the gemstone.

4. The method of claim 1, wherein the pressure in the reaction space is between 0.1 mbar and 100 mbar when the first or the second precursor is introduced to the reaction space.

5. The method of claim 1, wherein the temperature of the surface of the substrate comprising the gemstone is in the range of 150° C. to 600° C. when the first or the second precursor is introduced to the reaction space.

6. The method of claim 1, wherein the method additionally comprises the steps of,
depositing a first transparent film having a first refractive index on the absorbing film by alternately introducing precursors to the reaction space, such that at least a portion of the introduced precursor adsorbs onto the substrate, and
depositing a second transparent film having a second refractive index, different from the first refractive index, on the first transparent film by alternately introducing precursors to the reaction space, such that at least a portion of the introduced precursor adsorbs onto the substrate,
to form a thin-film interference structure on the absorbing film.

7. A decorative coating on a gemstone to change the natural visual appearance of the gemstone, the decorative coating comprising an optically absorbing film to attenuate the transmission of visible light through the coating, the decorative coating being fabricated by a method comprising the steps of bringing the gemstone into a reaction space, and depositing the absorbing film on a substrate comprising the gemstone, wherein depositing the absorbing film on the substrate comprises the alternating steps of
introducing a first precursor to the reaction space such that at least a portion of the first precursor gets adsorbed onto the surface of the substrate, and subsequently purging the reaction space, and
introducing a second precursor to the reaction space such that at least a portion of the second precursor reacts with the portion of the first precursor adsorbed onto the surface of the substrate to form a conformal absorbing film on the substrate comprising the gemstone, and subsequently purging the reaction space,
and in that the material of the absorbing film is selected from the group of oxides, carbides, noble metals or a mixture thereof.

8. The decorative coating of claim 7, wherein the natural visual appearance of the gemstone is the natural color of the gemstone.

9. The decorative coating of claim 7, wherein the coating comprises
a first transparent film having a first refractive index on the absorbing film, and
a second transparent film having a second refractive index, different from the first refractive index, on the first transparent film, to form a thin-film interference structure on the absorbing film.

10. Use of the method of claim 1 for forming, on a gemstone, a decorative coating comprising a conformal absorbing film, for changing the natural visual appearance of the gemstone.

11. Use of the decorative coating of claim 7 on a gemstone, the decorative coating comprising a conformal absorbing film, for changing the natural visual appearance of the gemstone.
